(19) United States
(12) Patent Application Publication
(10) Pub. No.: US 2017/0212588 A1
(43) Pub. Date: Jul. 27, 2017

(54) WEARABLE POINTING DEVICE

(71) Applicant: Yong Hoon KIM, Seoul (KR)

(72) Inventor: Yong Hoon KIM, Seoul (KR)

(21) Appl. No.: 15/204,108

(22) Filed: Jul. 7, 2016

(30) Foreign Application Priority Data
Jan. 21, 2016 (KR) 10-2016-0007685

(51) Int. Cl. G06F 3/01; G06F 3/038; G06F 3/0485; G06F 3/041; G06F 3/02

(52) U.S. Cl. CPC G06F 3/014; G06F 3/0414; G06F 3/0416; G06F 3/0227; G06F 3/0485; G06F 3/038; G06F 2203/0331

(57) ABSTRACT

There is provided a wearable pointing device comprising: a body; and a finger-mounted portion coupled to the body, wherein the body comprises: a coordinate input interface configured to sense a touch and movement of a second finger thereon to generate a cursor movement signal; a first button interface disposed on the first face of the body and adjacent to the coordinate input interface, wherein the first button interface is configured to generate a pop-up signal in a response to a pressure input thereto by the second finger; and a scroll input interface disposed on the first face of the body and adjacent to the coordinate input interface, wherein the scroll input interface is configured to generate a screen scrolling signal in a response to a pressure input thereto by the second finger.

### CROSS-REFERENCE TO RELATED APPLICATION

This application claims the benefit of Korea Patent Application No. 10-2016-0007685 filed on Jan. 21, 2016, the entire content of which is incorporated herein by reference for all purposes as if fully set forth herein.

### BACKGROUND

Field of the Present Disclosure

The present disclosure relates to a wearable pointing device, and, more specifically, to a wearable pointing device mounted on finger to provide an input signal to a computer.

Discussion of the Related Art

The user input interface device to the computer may include a mouse device. However, this conventional mouse device may cause the user thereof to have a carpal tunnel syndrome due to a long time use of the device.

In order to solve the problem, the finger-mounted type input interface device has been disclosed. However, the previous finger-mounted type input interface device has a position input inaccuracy on the screen of the computer due to a shaking of the hand of the user and/or a sensing inaccuracy of a space sensor.

### SUMMARY

Thus, there is a need for a finger-mounted type input interface with lack of the carpal tunnel syndrome due to a long time use of the device and with a position input accuracy on the screen of the computer comparable to the conventional mouse device.

In one aspect, there is provided a wearable pointing device comprising: a body; and a finger-mounted portion coupled to the body, wherein the finger-mounted portion wraps at least one finger including a first finger of a user to allow the body to be secured to the finger of the user, wherein the body comprises: a coordinate input interface protruding from a first face of the body, wherein the coordinate input interface is configured to sense a touch and movement of a second finger thereon to generate a cursor movement signal, and to generate a first signal in a response to a pressure input thereto by the second finger, wherein the second finger is not wrapped by the finger-mounted portion; a first button interface disposed on the first face of the body and adjacent to the coordinate input interface, wherein the first button interface is configured to generate a second signal in a response to a pressure input thereto by the second finger, wherein the first and second signals are different; and a scroll input interface disposed on the first face of the body and adjacent to the coordinate input interface, wherein the scroll input interface is configured to generate a screen scrolling signal in a response to a pressure input thereto by the second finger.

In one embodiment, the scroll input interface comprises: a first scroll button interface configured to an upwards screen-scrolling signal in a response to a pressure input thereto by the second finger; and a second scroll button interface configured to a downwards screen-scrolling signal in a response to a pressure input thereto by the second finger.

In one embodiment, a first line between the first scroll button interface and the coordinate input interface, a second line between the coordinate input interface and the second scroll button interface, and a third line between the first scroll button interface and the second scroll button interface form a triangle, wherein the first line has a length equal to that of the second line.

In one embodiment, the scroll input interface is configured: to generate a first range scrolling signal in a response to a first pressure input to one of the first scroll button interface and the second scroll button interface by the second finger; and to generate a second range scrolling signal in a response to a second pressure input to said one of the first scroll button interface and the second scroll button interface by the second finger within a predetermined time period after the first pressure input, wherein the second range is larger than the first range on the same screen.

In one embodiment, the body includes a communication module configured to send the cursor movement signal, the first and second signals, and the scrolling signal in a wireless manner to a computer external to the device.

In one embodiment, the scroll input interface is disposed between the coordinate input interface and the first button interface.

In one embodiment, the coordinate input interface is configured: to generate the first signal in a response to the first pressure input thereto by the second finger; and to generate a third signal in a response to a second pressure input thereto by the second finger within a predetermined time period after the first pressure input, wherein the first signal is different from the third signal which is different from the second signal.

In one embodiment, the first signal indicates a selection of an object on the screen, wherein the third signal indicates an activation of an application corresponding to an object on the screen.

In one embodiment, the body further includes a second button interface, wherein the second button interface is configured to generate a resolution-change signal in a response to a pressure input thereto by the second finger, wherein the resolution-change signal instructs the coordinate input interface to change from a first state to a second state, wherein in the first and second states, the coordinate input interface senses the movement of the second finger thereon with the first and second resolutions respectively, wherein the first and second resolutions are different.

In one embodiment, the body further comprises a light emitting diode (LED) configured to render different colors corresponding to the first state and the second state respectively.

In one embodiment, the second signal indicates a pop-up of an object on the screen selected via the first signal.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 shows a perspective view of a body of a wearable pointing device in accordance with one embodiment of the present disclosure.

FIG. 2 shows one example of a state in which a wearable pointing device in accordance with one embodiment of the present disclosure is worn on a finger.

FIG. 3 illustrates a block diagram of a wearable pointing device in accordance with one embodiment of the present disclosure.

FIG. 4 illustrates a flow chart of operations of the wearable pointing device in accordance with one embodiment of the present disclosure when the coordinate input interface is touch-pressed.

FIG. 5 illustrates a flow chart of operations of the wearable pointing device in accordance with one embodiment of the present disclosure when the scroll button input interface is touch-pressed.

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

Hereinafter, embodiments of the present disclosure will be described in details with reference to attached drawings.

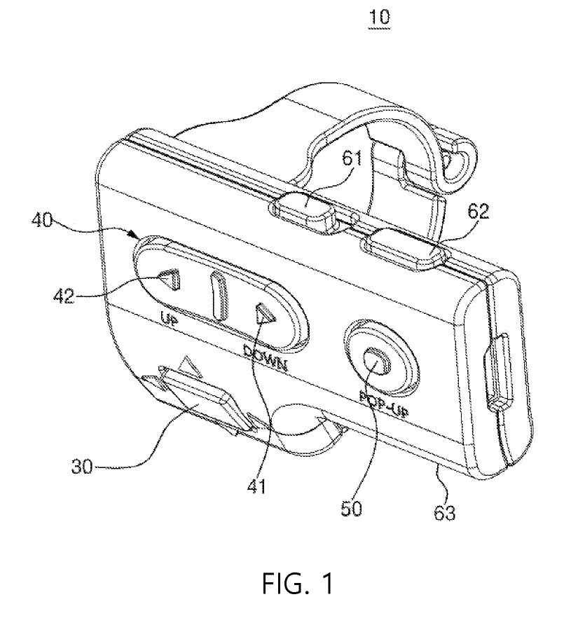

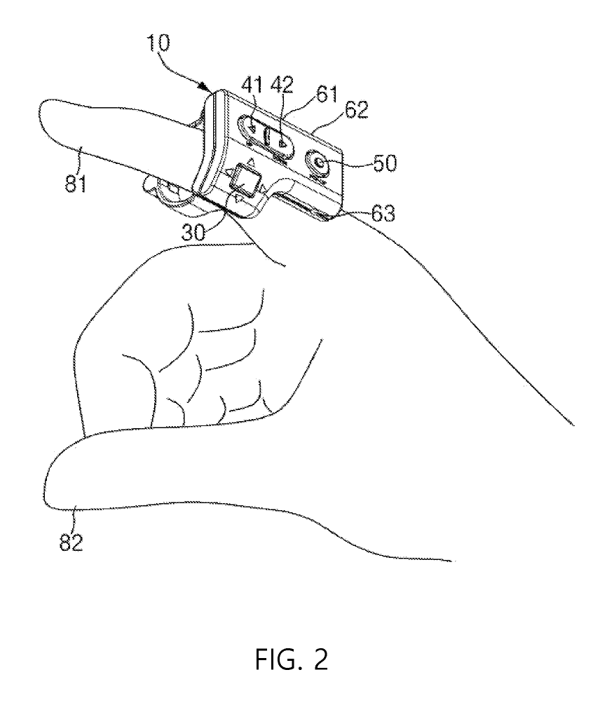

FIG. 1 shows a perspective view of a body of a wearable pointing device in accordance with one embodiment of the present disclosure. FIG. 2 shows one example of a state in which a wearable pointing device in accordance with one embodiment of the present disclosure is worn on a finger.

Referring to FIG. 1 and FIG. 2, a wearable pointing device in accordance with one embodiment of the present disclosure may include a body 10 and a finger-mounted portion 20.

The body 10 may include a coordinate input interface 30, a scroll input interface 40, a first button 50, a second button 62, a power button 61, and a LED 54, etc.

The body 10 may contact a first finger 81 as one side thereof. More specifically, the body 10 may contact the first finger 81 at one side thereof, and the finger-mounted portion 20 coupled to the body 10 wraps the first finger 81 to allow the body 10 to be secured to the first finger 81. In FIG. 1, the finger-mounted portion 20 is shown to wrap only one finger, that is, the first finger 81 to allow the body 10 to be worn on the user. The present disclosure is not limited thereto. For example, the finger-mounted portion 20 may wrap two least fingers including the first finger 81 to allow the body 10 to be secured to the user body.

In this connection, the finger-mounted portion 20 may be not limited particularly in terms of a material or mounting manner as long as it provides a tension larger than or equal to a certain magnitude between the body 10 and the first finger 81 fitting into the finger-mounted portion. That is, the finger-mounted portion 20 may be made of, for example, a silicon, or textile material, etc. The finger-mounted portion 20 may of a buckle type or Velcro type, etc. in terms of the fastening manner. The present disclosure is not limited thereto.

As shown in FIG. 1, the finger-mounted portion 20 may be configured to wrap the first finger 81 at a second or third knuckle to allow the body 10 to be secured to the finger. The second or third knuckle of the first finger 81 may refer to a second or third knuckle from a distal end of the first finger 81.

The coordinate input interface 30 may be disposed on one side face of the body 10. More specifically, the coordinate input interface 30 may protrude from one side face of the body 10. As shown in FIG. 1, the coordinate input interface 30 may have a rectangular side active vertical face. The present disclosure is not limited thereto. The coordinate input interface 30 may have a circular side active vertical face.

The coordinate input interface 30 may be of a touch type interface. For example, the coordinate input interface 30 may sense a touch-moment of the finger of the user thereon. That is, while the second finger 82 of the user may contacts and moves on the vertical side face (as shown in FIG. 1) of the coordinate input interface 30, the coordinate input interface 30 may sense a distance and a direction of the movement of the second finger 82. This may be equivalent to a movement of the mouse pointer on a screen on a GUI interface.

In an alternative, the coordinate input interface 30 may be of an optical type interface. For this, the coordinate input interface 30 may include an optical sensor, etc. configured to sense a movement of the finger over and along the vertical side active face. When the coordinate input interface 30 includes the optical sensor, the optical sensor may include an image sensor configured to emit a light beam from a light source embedded in the coordinate input interface 30 and receive a reflected light beam from the finger.

Thus, the coordinate input interface 30 may sense the movement of the second finger 82 in a contact or non-contact manner. Thus, the coordinate input interface 30 may generate a signal which indicate a coordinate position.

The coordinate input interface 30 may sense a touch-pressure of the second finger 82. Thus, in a response to the touch-pressure, the coordinate input interface 30 may generate a signal to indicate a selection of the coordinate position corresponding to the position of the finger. This may correspond to a push of a left button of the conventional mouse device.

In use, when the user may put the right hand on the desk, etc. with lack of fingers force, the index finger may naturally contact a thumb. Further, the finger-mounted portion 20 may be configured to wrap the first finger 81, for example, the index finger, at a second or third knuckle to allow the body 10 to be secured to the finger. Thus, naturally, the second finger 82, for example, a thumb may contact the coordinate input interface 30 to input the first signal. That is, the user may manipulate the first finger 81 or second finger 82 in a minimum loaded manner. This may lead to a less burden to the hand of the user for a long time use of the wearable pointing device in accordance with one embodiment of the present disclosure. This may prevent a carpal tunnel syndrome due to a heavy load to the hand.

The body 10 may have the scroll input interface 40 formed thereon. The scroll input interface 40 may be adjacent to the coordinate input interface 30. The scroll input interface 40 may include a first scroll button 41 and second scroll button 42.

The first scroll button 41 and second scroll button 42 are horizontally arranged as shown in FIG. 1. An extension line between a central point between the first scroll button 41 and second scroll button 42 and a center point of the scroll input interface 40 may be referred to a first vertical line. An extension line between the first scroll button 41 and a center point of the scroll input interface 40 may be referred to a first oblique line. An extension line between the second scroll button 42 and a center point of the scroll input interface 40 may be referred to a second oblique line. Thus, the first and second oblique lines may be oblique to the first vertical line. This may allow each of the first scroll button 41 and the second scroll button 42 to be arranged in an oblique way relative to the scroll input interface 40. This may allow the movement between the scroll input interface 40 and each of the first scroll button 41 and the second scroll button 42 to be more easily executed than when each of the first scroll button 41 and the second scroll button 42 vertically overlaps the scroll input interface 40. In this connection. each of the first scroll button 41 and the second scroll button 42 may be arranged symmetrically in a predetermined-angled way relative to the scroll input interface 40.

The first scroll button 41 and second scroll button 42 may allow to generate a scrolling signal to allow the screen to be scrolled in a GUI interface. More specifically, the first scroll button 41 may to generate an upwards scrolling signal to allow the screen to be upwards scrolled in a GUI interface. The second scroll button 42 may to generate a downwards scrolling signal to allow the screen to be downwards scrolled in a GUI interface. To the contrary, the first scroll button 41 may to generate a downwards scrolling signal to allow the screen to be downwards scrolled in a GUI interface, while, the second scroll button 42 may to generate an upwards scrolling signal to allow the screen to be upwards scrolled in a GUI interface

The first button 50 may be disposed on the vertical side face of the body 10 as shown in FIG. 1. More specifically, as shown in FIG. 1, the coordinate input interface 30, scroll input interface 40 and first button 50 may be arranged in a “L” shape on the vertical side face of the body 10. This may minimize a movement of the second finger 82 in order to manipulate the wearable pointing device. The present disclosure is not limited thereto. The coordinate input interface 30 and first button 50 and scroll input interface 40 may be arranged in a line while the scroll input interface 40 is disposed between the coordinate input interface 30 and first button 50.

The pressing of the first button 50 by the second finger 82 may allow to generate a signal corresponding to a pop-up signal in the GUI interface. That is, this may be equivalent to a right button click signal of the convention mouse device.

The body 10 has a top face as shown in FIG. 1 on which the second button 62, and the power button 61 are disposed. The body 10 has a bottom face as shown in FIG. 1 on which the LED 63 is disposed.

The pressing of the second button 62 may allow to generate a signal to allow the wearable pointing device from a first state to a second state. In this connection, the first state may correspond to a state in which the coordinate input interface 30 senses the movement of the second finger 82 with a first resolution. The second state may correspond to a state in which the coordinate input interface 30 senses the movement of the second finger 82 with a second resolution. The present disclosure is not limited thereto.

The first resolution and second resolution may be different. In this connection, the first resolution and second resolution being different may mean that, provide that the movements of the second finger 82 on the coordinate input interface 30 are the same between the first and second states, movement distances of the mouse pointer on a screen on the GUI interface corresponding to the first and second states respectively may be different.

For the coordinate input interface 30 of the wearable pointing device of the present disclosure, the second finger 82 may less move in order to move the mouse pointer on the screen than when using the conventional mouse device running on the planar desk. Thus, in order to move the mouse pointer on the screen by a larger distance, the second finger 82 should run from one end of the coordinate input interface 30 to an opposite end of the coordinate input interface 30.

However, for the wearable pointing device of the present disclosure, by changing the sensing resolution of the coordinate input interface 30 from the first state to the second state, the small movement of the second finger 82 on the coordinate input interface 30 may allow the movement of the mouse pointer on the screen by a larger distance in the GUI interface.

The wearable pointing device of the present disclosure uses the first and second states. The present disclosure is not limited thereto. The wearable pointing device of the present disclosure may use at least three resolution states of the coordinate input interface 30. Thus, the resolution states of the coordinate input interface 30 may be selected depending on types of applications to be manipulated by the user.

The LED 63 may emit a light beam when the wearable pointing device operates. More specifically, the LED 63 may render the different colors based on the wearable pointing device operating in the first state or second state. Thus, the user may easily perceive a current sensing resolution of the coordinate input interface 30 of the wearable pointing device.

The power button 61 may be used to turn on or off the wearable pointing device via a pressing thereof.

Although not shown, the wearable pointing device may have charging or computer-connection terminals on the body thereof.

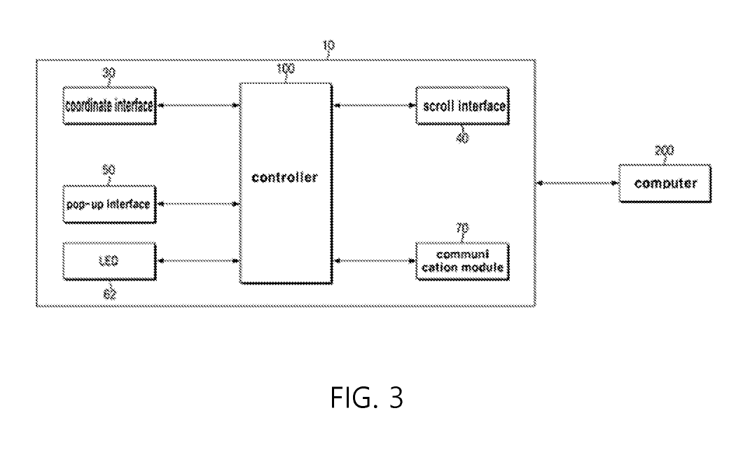

FIG. 3 illustrates a block diagram of a wearable pointing device in accordance with one embodiment of the present disclosure.

Referring to FIG. 3, the wearable pointing device may have the body 10 including a controller 100 coupled to the coordinate input interface 30, the scroll input interface 40, etc. The controller 100 may receive signals from the coordinate input interface 30, scroll input interface 40 and button 50 and send the signals via a communication module 70 to a computer 200 external thereto.

The communication module 70 may send to the computer 200 an input signal generated by the wearable pointing device for the GUI interface. The communication module 70 may send the input signal to the computer 200, for example, in a wireless manner using RF (Radio Frequency), Bluetooth, etc.

Upon a receipt of the input signal from the wearable pointing device, the computer 200 may be configured to process the GUI interface based on the input signal. The computer may include a UMPC (Ultra Mobile PC), a workstation, a net-book, a PDA (Personal Digital Assistants), a portable computer, etc. The present disclosure is not limited thereto. That is, any computing system may be employed for the wearable pointing device of the present disclosure as long as it processes the GUI interface.

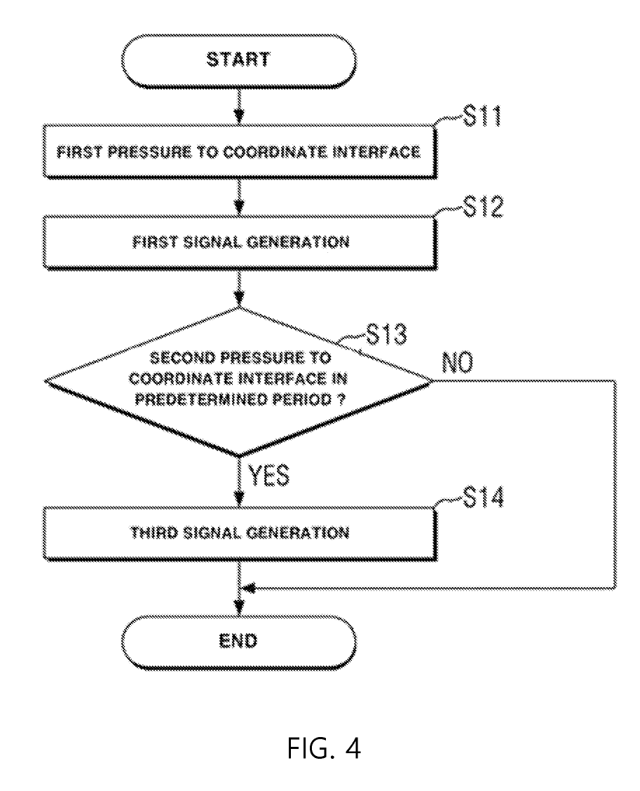

FIG. 4 illustrates a flow chart of operations of the wearable pointing device in accordance with one embodiment of the present disclosure when the coordinate input interface is touch-pressed.

Referring to FIG. 4, the coordinate input interface 30 may receive a pressure input S11, and may generated a first signal based on the pressure input S12, and may determine whether a further pressure input to the coordinate input interface for the same position as in the first input pressure occurs within a predetermined period S13, and, upon determination that the further pressure input to the coordinate input interface occurs within the predetermined period, may generate a third signal S14.

That is, the coordinate input interface 30 generating the third signal may occur when the further pressure input to the coordinate input interface occurs within the predetermined period after the first pressure input allowing generation of the first signal. The third signal generated by the coordinate input interface 30 may be equivalent to a signal generated by a double click of a mouse left button in the GUI interface.

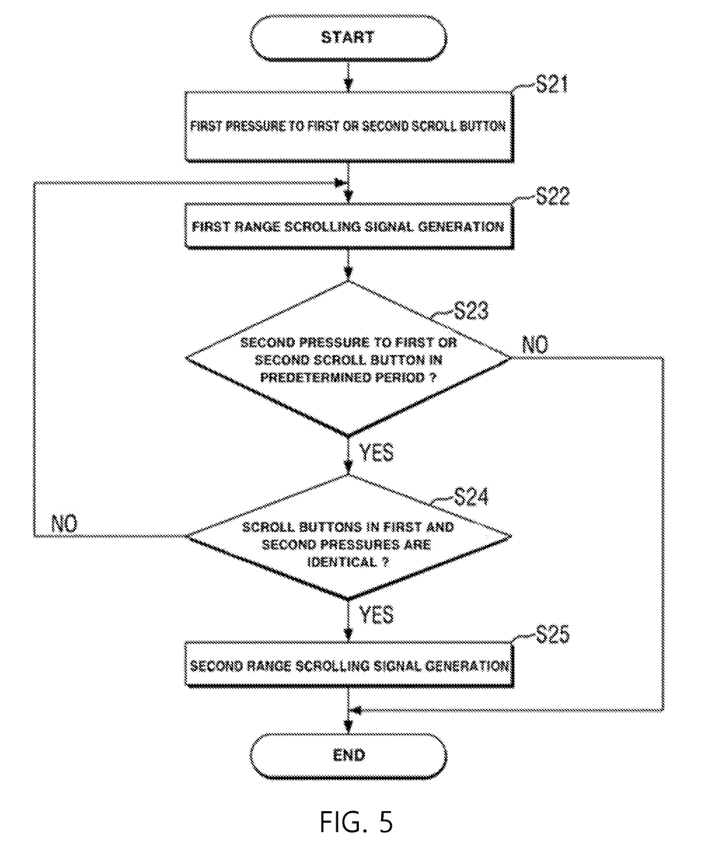

FIG. 5 illustrates a flow chart of operations of the wearable pointing device in accordance with one embodiment of the present disclosure when the scroll button input interface is touch-pressed.

Referring to FIG. 5, the first or second scroll button of the scroll button input interface receives a pressure input S21, and may generate a first range scrolling signal S22, and may determine whether a further pressure input to the first or second scroll button occurs within a predetermined period S23, and, if so, may determine whether the further pressure input is directed to the same scroll button as the first pressure input is directed to S24 and, if so, may generate a second range scrolling signal.

In this connection, the second scrolling range of the second range scrolling signal may be larger than the first scrolling range of the first range scrolling signal. That is, when the further pressure input to the same scroll button as the first pressure input is directed to occurs within the predetermined period, the second scrolling range larger than the first scrolling range may be scrolled. This may accelerate the screen scrolling operation in the GUI interface.

In this connection, the second range may be larger 5 to 10 times than the first range. The present disclosure is not limited thereto. the ratio of the second range to the first range may vary depending on types of the applications to be manipulated by the user.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A wearable pointing device comprising:
a body; and
a finger-mounted portion coupled to the body, wherein the finger-mounted portion wraps at least one finger including a first finger of a user to allow the body to be secured to the finger of the user,
wherein the body comprises:
a coordinate input interface protruding from a first face of the body, wherein the coordinate input interface is configured to sense a touch and movement of a second finger thereon to generate a cursor movement signal, and to generate a first signal in a response to a pressure input thereto by the second finger, wherein the second finger is not wrapped by the finger-mounted portion;
a first button interface disposed on the first face of the body and adjacent to the coordinate input interface, wherein the first button interface is configured to generate a second signal in a response to a pressure input thereto by the second finger, wherein the first and second signals are different; and
a scroll input interface disposed on the first face of the body and adjacent to the coordinate input interface, wherein the scroll input interface is configured to generate a screen scrolling signal in a response to a pressure input thereto by the second finger.

2. The device of claim 1, wherein the scroll input interface comprises:
a first scroll button interface configured to an upwards screen-scrolling signal in a response to a pressure input thereto by the second finger; and
a second scroll button interface configured to a downwards screen-scrolling signal in a response to a pressure input thereto by the second finger.

3. The device of claim 2, wherein a first line between the first scroll button interface and the coordinate input interface, a second line between the coordinate input interface and the second scroll button interface, and a third line between the first scroll button interface and the second scroll button interface form a triangle, wherein the first line has a length equal to that of the second line.

4. The device of claim 2, wherein the scroll input interface is configured:
to generate a first range scrolling signal in a response to a first pressure input to one of the first scroll button interface and the second scroll button interface by the second finger; and
to generate a second range scrolling signal in a response to a second pressure input to said one of the first scroll button interface and the second scroll button interface by the second finger within a predetermined time period after the first pressure input,
wherein the second range is larger than the first range on the same screen.

5. The device of claim 1, wherein the body includes a communication module configured to send the cursor movement signal, the first and second signals, and the scrolling signal in a wireless manner to a computer external to the device.

6. The device of claim 1, wherein the scroll input interface is disposed between the coordinate input interface and the first button interface.

7. The device of claim 1, wherein the coordinate input interface is configured:
to generate the first signal in a response to the first pressure input thereto by the second finger; and
to generate a third signal in a response to a second pressure input thereto by the second finger within a predetermined time period after the first pressure input,
wherein the first signal is different from the third signal which is different from the second signal.

8. The device of claim 7, wherein the first signal indicates a selection of an object on the screen, wherein the third signal indicates an activation of an application corresponding to an object on the screen.

9. The device of claim 1, wherein the body further includes a second button interface, wherein the second button interface is configured to generate a resolution-change signal in a response to a pressure input thereto by the second finger, wherein the resolution-change signal instructs the coordinate input interface to change from a first state to a second state, wherein in the first and second states, the coordinate input interface senses the movement of the second finger thereon with the first and second resolutions respectively, wherein the first and second resolutions are different.

10. The device of claim 9, wherein the body further comprises a light emitting diode (LED) configured to render different colors corresponding to the first state and the second state respectively.

11. The device of claim 1 wherein the second signal indicates a pop-up of an object on the screen selected via the first signal.
